(19) United States
(12) Patent Application Publication
(10) Pub. No.: US 2007/0205890 A1
(43) Pub. Date: Sep. 6, 2007

(54) Location awareness system

(76) Inventor: Karen Klemmer Brown, Bridgewater, NJ (US)

Correspondence Address: Ms. Karen K. Brown, 16 Totten Drive, Bridgewater, NJ, 08807-2367, US

(21) Appl. No.: 11/368,105

(22) Filed: Mar. 6, 2006

(51) Int. Cl. G08B 1/08

(52) U.S. Cl. 340/539.23

(57) ABSTRACT

The arrangement of the present invention allows for a proximity warning system that can indicate the presence of an identified person, animal or object within the range of a sensor. In one application, this invention will warn hunters that an identified person, animal or object is within the field of fire of the weapon.

### FIELD OF THE INVENTION

The present invention relates to a proximity warning system to be used in situations where an individual needs to be aware of the presence of another person, animal, or object. In particular, this invention relates to warning hunters about the presence of another hunter, animal or other object that is potentially within the field of fire.

### BACKGROUND OF THE INVENTION

Hunting is in many ways an inherently dangerous activity. As a consequence, hunters have developed a variety of protocols and tools to minimize the risk of accidental shootings. Current safety measures include strict rules and expectations regarding the area of a hunt, when to load a weapon, confirmation of the target, use of highly visible protective clothing and more. Despite these precautions, every year individuals are accidentally shot during a hunt as a consequence of a breakdown in situational awareness. Such accidents are physically and emotionally painful both for the hunter and the victim and generate substantial expense in medical care and litigation.

### SUMMARY OF THE INVENTION

The need remaining in the art is addressed by the present invention, which relates to a proximity indicator which can warn the shooter about the presence of a person, animal, or other object that may be in the field of fire and should not be shot at.

In accordance with the present invention, a beacon is generated by the person, animal or object in the field of fire by means of either reflection of an illuminator or by having a small radio transmitter attached to the person, animal, or object. The gun of the hunter is equipped with a highly directional receiver, mounted below the barrel or above the sighting scope. When the weapon is in the firing position, if the directional receiver captures a signal from the beacon, a warning sound or light is triggered informing the hunter of the potential risk of firing. Additionally, it is possible to imagine a “lock-out” mechanism, preventing the gun from firing when the beacon is detected.

Various other features and embodiments of the present invention will become apparent during the course of the following discussion and by reference to the associated drawings.

### BRIEF DESCRIPTION OF THE DRAWINGS

Referring now to the drawings,

FIG. 1 illustrates a method of implementation using radio transmitters and gun mounted detectors; and

FIG. 2 contains an illustration of an implementation using an optical illuminator and detector mounted on a gun with the beacon signal reflected from the at-risk target.

### DETAILED DESCRIPTION

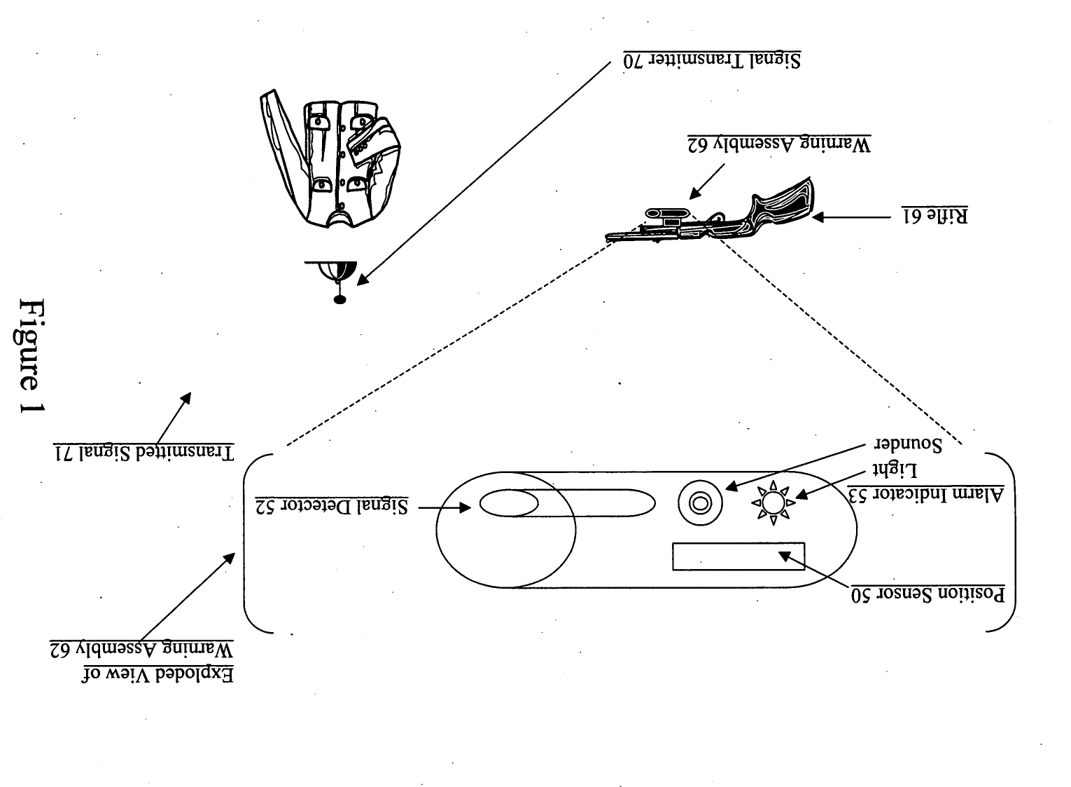

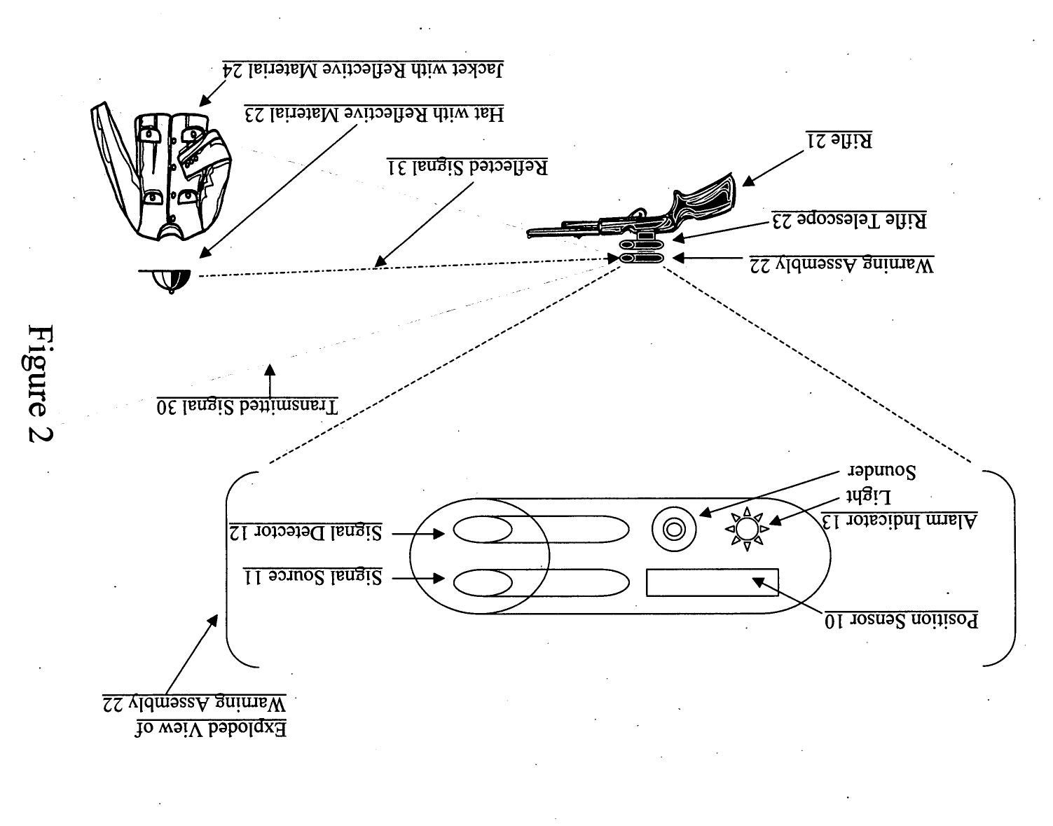

FIGS. 1 and 2 illustrate exemplary designs of a proximity warning system that can be used to provide the function of the present invention. As mentioned above, hunting safety is very important but not perfect, and this invention will improve the margin of safety in hunting and other similar activities where proximity awareness is important and uncertain.

In FIG. 1, a small transmitter, typically a radio, would be attached to the person, animal or object potentially in the field of fire. In this example, the signal transmitter 70 is shown attached to a hat. In typical operation, signal transmitter 70 will broadcast a continuous signal, a series of intermittent signals or a coded signal simply announcing its presence, shown in FIG. 1 as transmitted signal 71. When the rifle 61 is brought into a position for firing (typically, an approximately horizontal position), the position sensor 50 activates the signal detector 52.

The signal detector 52 is a directional receiver looking for the existence of a recognizable transmitted signal 71. When the signal detector 52 recognizes the existence of a transmitted signal 71, warning alarm indicator 53 is activated informing the hunter of the proximity of a person, animal or object potentially in the field of fire. The warning alarm indicator 53 is typically some combination of light and sound, but may also include a locking mechanism to physically prevent the gun from firing.

Care is required in the design and implementation of both the signal transmitter 70 and the signal detector 52. An appropriate amplitude and frequency of transmission needs to be chosen that assures good signal propagation in the environment, low power consumption, minimal risk of interference from other potential signal sources, as well as allowing for a practical signal detector 52 to be built. Signal detector 52 will need to have a radio receiver that is appropriately directional and selective in identifying only the transmitted signal 71 as well as recognizing appropriate signals within an area consistent with the path of a potential gunshot.

FIG. 2 is a modified implementation of the proximity warning system described above. In FIG. 2, the signal source 11 is attached to the rifle 21 as part of warning assembly 22. The persons, animals or objects being protected are outfitted with reflective material, typically as part of a hat 23, jacket 24, vest or other outerwear. When the rifle 21 was brought into firing position, position sensor 10 would activate the system, turning on both the signal source 11 and signal detector 12.

In a preferred embodiment, the signal source 11 would be a laser pointer, with the transmitted signal 30 being a slightly diffused projection of the laser light. The reflective materials in the hat 23, jacket 24 or other outerwear would have embedded corner reflectors, so that any light striking the corner reflector would be returned in exactly the same path at it entered the reflector. Note that corner reflector technology is common and readily available, and is regularly used in reflective tapes, safety garments and highway striping. When the transmitted signal 30 struck the reflective materials in the hat 23 or jacket 24, a reflected signal 31 would be returned towards the warning assembly 22. When the returned signal was detected by signal detector 12, the alarm indicator 13 would light or sound informing the hunter of the potential of an person, animal or object in the proximity of the field of fire.

Further note that although this invention is largely intended for proximity awareness and improving safety, it could also be used as a training device by providing positive feedback when an target is within the path of a weapon projectile.

Those skilled in the art will recognize that various modifications and variations can be made in the preceding examples without departing from the scope or spirit of the invention. The specification is not considered to limit the invention. Instead, it provides examples and explanations to allow persons of ordinary skill to appreciate different ways to practice this invention. The following claims are thus used to define the true scope and spirit of the present invention.

What is claimed is:

1. A system for providing proximity information to hunters or other individuals, the system comprising a signal source identifying a potential target; a directional signal receiver able to sense when the signal source is in or near the path of the weapon projectile; and an indicator mechanism to indicate that the signal source is near or within the path of the weapon projectile.

2. The system as defined in claim 1 wherein the signal source is a radio transmitter located on the target.

3. The system as defined in claim 1 wherein the signal source is a directional radio or optical transmitter colocated with the receiver and with the detected signal being a reflection from the target.

4. The system as defined in claim 1 where the signal source is encoded with a code uniquely associated with the receiver.

5. The system as defined in claim 1 where the indicator mechanism is an audible alarm.

6. The system as defined in claim 1 where the indicator mechanism is a visual signal.

7. The system as defined in claim 1 where the indicator mechanism is a lock-out mechanism preventing a weapon from firing.

8. The system as defined in claim 1 where there is a position sensor that enables the proximity indication system only when the weapon is in firing position.
